(19) United States
(12) Patent Application Publication
(10) Pub. No.: US 2025/0080685 A1
(43) Pub. Date: Mar. 6, 2025

(54) MOTION FORECASTING FOR SCENE FLOW ESTIMATION

(71) Applicant: QUALCOMM Incorporated, San Diego, CA (US)

(72) Inventors: Ming-Yuan Yu, Austin, TX (US); Varun Ravi Kumar, San Diego, CA (US); Senthil Kumar Yogamani, Headford (IE)

(21) Appl. No.: 18/462,191

(22) Filed: Sep. 6, 2023

(51) Int. Cl. H04N 5/14; G01S 17/86; G06V 10/44; G06V 10/80

(52) U.S. Cl. CPC H04N 5/145; G01S 17/86; G06V 10/44; G06V 10/806

(57) ABSTRACT

A method of image processing includes receiving first feature data from image content captured with a sensor, the first feature data having a first set of states with values that change non-linearly over time, generating second feature data based at least in part on the first feature data, the second feature data having a second set of states with values that change approximately linearly over time relative to a linear operator, wherein the second set of states is greater than the first set of states, and predicting movement of one or more objects in the image content based at least in part on the second feature data.

### TECHNICAL FIELD

This disclosure relates to forecasting of moving objects in a scene.

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indicative of the existence and location of other objects around the autonomous driving vehicle. In some examples, such an autonomous driving vehicle may be referred to as an ego vehicle. A vehicle having an advanced driver-assistance system (ADAS) is a vehicle that includes systems which may assist a driver in operating the vehicle, such as parking or driving the vehicle.

### SUMMARY

To implement the navigation functionality, a system (e.g., ADAS, robotics, drones, etc.) may be configured to perform motion forecasting of objects in a scene. This disclosure describes example techniques of efficient motion forecasting based on converting a non-linear dynamic system to a linear dynamic system. For instance, this disclosure describes example techniques to perform efficient motion forecasting using Koopman operator theory for scene flow estimation. A conversion from a non-linear dynamic system (e.g., motion of objects in a busy urban intersection) to a linear dynamic system may result in a linear dynamic system that is computationally efficient for motion forecasting.

Some techniques rely on object-level detection and tracking algorithms based on past trajectories of the detected objects, but may not provide accurate forecast of object motion due to occlusion, there being many objects, and complex interactions in captured images or change in scene. Scene flow techniques for motion forecasting of objects may not require object-level detection and tracking algorithms, but can result in a non-linear forecasting model that may be complex and require many processing cycles of a processing circuitry for usage. With the example techniques, by converting from a non-linear dynamic system to the linear dynamic system, the processing circuitry may perform the scene flow estimation techniques for motion forecasting of objects in a time and processing efficient manner.

In one example, the disclosure describes a method of image processing, the method comprising: receiving first feature data from image content captured with a sensor, the first feature data having a first set of states with values that change non-linearly over time; generating second feature data based at least in part on the first feature data, the second feature data having a second set of states with values that change approximately linearly over time relative to a linear operator, wherein the second set of states is greater than the first set of states; and predicting movement of one or more objects in the image content based at least in part on the second feature data.

In one example, the disclosure describes a system for image processing, the system comprising: one or more memories; and processing circuitry coupled to the one or more memories and configured to: receive first feature data from image content captured with a sensor, the first feature data having a first set of states with values that change non-linearly over time; generate second feature data based at least in part on the first feature data, the second feature data having a second set of states with values that change approximately linearly over time relative to a linear operator, wherein the second set of states is greater than the first set of states; and predict movement of one or more objects in the image content based at least in part on the second feature data.

In one example, the disclosure describes a computer-readable storage medium storing instructions thereon that when executed cause one or more processors to: receive first feature data from image content captured with a sensor, the first feature data having a first set of states with values that change non-linearly over time; generate second feature data based at least in part on the first feature data, the second feature data having a second set of states with values that change approximately linearly over time relative to a linear operator, wherein the second set of states is greater than the first set of states; and predict movement of one or more objects in the image content based at least in part on the second feature data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 is a flowchart illustrating an example process predicting movement of objects.

FIG. 3 is a conceptual diagram illustrating information indicative of predicted movement of objects.

FIG. 4 is a flowchart illustrating an example process for determining a linear operator for predicting movement of objects.

FIG. 5 is a flowchart illustrating an example method in accordance with one or more examples described in this disclosure.

### DETAILED DESCRIPTION

Various example systems utilize image content captured from one or more sensors for predicting movement, and may use example techniques described in this disclosure. As some examples, robotic systems, drones, advanced driver assistance system (ADAS), etc. may utilize the example techniques described in this disclosure. For ease, the examples are described with respect to ADAS.

An ADAS uses image content captured from one or more sensors for assisting a driver in various driving scenarios. For instance, the ADAS may predict motion of objects in a scene to assist with self-driving, brake warning, etc. A scene refers to a view of a real-world environment that contains multiples surfaces and objects. In some cases, predicting motion in real-world environments, such as crowded scenes, can be complex due to occlusion of objects, there being many objects and surfaces in the scene, and the interaction between objects and surfaces in a scene being complex.

One example of predicting motion of objects in a scene is referred to as scene flow estimation. Scene flow estimation refers to examples where a system (e.g., ADAS or other example systems) estimates motion of samples of image content between two consecutive or possibly non-consecutive image frames of image content captured by the one or more sensors. Scene flow estimation techniques tend to provide better motion estimation as compared to techniques that rely on object detection and/or tracking. For instance, object detection may be a machine learning based detection technique and if there is domain shift (e.g., the training data did not properly represent a scene), object detection may not function well for predicting objection motion. Tracking algorithms may not function well if there is occlusion (e.g., the tracking algorithm may not correctly resolve motion of an object if that object were occluded for one or more image frames).

Scene flow estimation for predicting object motion may not require object-level detection or rely on tracking algorithms. However, scene flow estimation for predicting object motion may require usage of non-linear forecasting models that tend to be complex and require many processing cycles. Non-linear forecasting models refer to models representing non-linear dynamic system. A non-linear dynamic system may be a system in which values for states of a scene change non-linearly over time.

A state of a scene may refer to characteristics of objects or surfaces in the scene. For instance, velocity and direction of objects are two examples of states of a scene. Changing non-linearly over time means that a change of values of a state from a first instance to a second instance cannot be represented by a linear operator. That is, in a non-linear dynamic system, the value of a state in the second instance cannot be predicted relative to a linear operator applied to the value of the state in the first instance. As an example, the velocity or direction of objects of a scene may change non-linearly.

This disclosure describes example techniques to convert a non-linear dynamic system (e.g., a busy urban intersection in a scene) to a linear dynamic system. A linear dynamic system may be a system in which values of the states of a scene change linearly over time. For instance, in a linear dynamic system, a change of a value of a state from a first instance to a second instance may be represented by linear operator. In a linear dynamic system, the value of the state in the second instance may be predicted relative to a linear operator applied to the value of the state in the first instance.

However, as described above, in a scene where predicting motion of objects (e.g., in ADAS) may be useful, the states of the scene are non-linear. To convert the non-linear dynamic system to a linear dynamic system, a system (e.g., ADAS or other systems) may derive addition states. For example, processing circuitry of the system may receive image content captured with a sensor, and extract feature data. Feature data may be information related to identify shapes, lines, or other features in image content of a scene captured with a sensor that may correspond to real-world objects of interest in the scene.

In this example, the feature data, referred to as first feature data, may have a first set of states that change non-linearly over time (e.g., values of the first feature data for the first set of states change non-linearly over time). For instance, the first feature data may be referred to as first feature tensor. The first feature tensor may be a matrix in an N-dimensional space. Each dimension of the N-dimensions may refer to one of the states in the first set of states.

In general, the first feature data having the first set of states with values that change non-linearly over time include examples where the first set of states are such that the values of the first set of states tend to have the characteristic of changing non-linearly. It may be possible that the first feature data having the first set of states with values that change non-linearly over time include examples where the values of the first set of states are required to change non-linearly over time. However, the example techniques are not so limited. The examples of the first feature data having the first set of states with values that change non-linearly should not be limited to examples where there is a requirement that the values change non-linearly, and include examples where values are for states that tend to exhibit non-linear behavior. It may be possible that some of the values for the first set of states in the first feature data exhibit linear behavior at times.

In one or more examples, to convert the non-linear dynamic system to a linear dynamic system, the processing circuitry of the system may derive additional states by lifting the first set of states to a higher dimensional space. That is, the processing circuitry may generate second feature data based at least in part on the first feature data, where the second feature data has a second set of states that is greater than the first set of states.

As an example, for a state variable “x,” the processing circuitry may generate a collection of states [x, x\hat{ }2, x\hat{ }3, . . . , sin(x), cos(x), . . . ]. In this example, the variable “x” is being lifted to a higher dimensional space. There may be various examples of functions used to lift a state variable, but common ones are polynomials and/or trigonometry functions. Lifting may be helpful in cases where the original states does not capture the nature of the data. For example, when processing circular data structures (e.g. point clouds from a 360-deg LiDAR) applying sine/cosine may lift the state and capture the nature of the data.

In accordance with one or more examples described in this disclosure, the second feature data having the second set of states may also have the property that the second set of states change approximately linearly over time relative to a linear operator. That is, the values of the second set of states may change approximately linearly over time relative to the linear operator. For example, it may be possible to predict the change in values of the second set of states over time relative to the linear operator. For instance, a change of the values of the second set of states from a first instance to a second instance may be represented by linear operator. That is, the values of the second set of states in the second instance may be predicted relative to a linear operator applied to the values of the second set of states in the first instance.

In general, the second feature data having the second set of states with values that change approximately linearly over time include examples where the second set of states are such that the values of the second set of states tend to have the characteristic of changing linearly. It may be possible that the second feature data having the second set of states with values that change linearly over time include examples where the values of the second set of states are required to change linearly over time. However, the example techniques are not so limited. The examples of the second feature data having the second set of states with values that change approximately linearly should not be limited to examples where there is a requirement that all of the values change linearly, and include examples where some of the values are for states that tend to exhibit linear behavior relative to the linear operator.

One or more servers may determine the linear operator based on training data. For instance, one example of the linear operator is the Koopman operator, sometimes represented as “g”. In one or more examples, the training data may include a first training set of feature data having the second set of states (e.g., lifted dimensions) and a second training set of predicted feature data having the second set of states. The first training set of feature data may be feature data that is captured from a plurality of different vehicles, drones, or other systems in a variety of different environments. Some of the first training set of feature data may be used as inputs and some of the first training set of feature data may be used as ground truths. For example, the first training set may include feature data from a set of image frames (e.g., sequential image frames at different times). That is, each of the image frame may be associated with a respective timestamp.

During training, processing circuitry of the one or more servers may input the current feature data having a first timestamp and predict current feature data having a second timestamp (e.g., the feature data for the next timestamp). Processing circuitry of the one or more servers may compare (e.g., determine a difference between) the predicted current feature data having the second timestamp and the current feature data having the second timestamp. Based on the comparison, the processing circuitry of the one or more servers may a linear operator that minimizes the difference.

For example, assume there are sequential frames 1 and 2 and sequential frames 3 and 4. In this example, the processing circuitry of the one or more servers may utilize an initial linear operator, and using feature data of frame 1, predict the feature data of frame 2 based on the initial linear operator. The processing circuitry may determine a difference value in the feature data of the predicted frame 2 and the actual feature data of frame 2. The processing circuitry may perform similar operations with frames 3 and 4. The processing circuitry may use the various difference values to update the value of the linear operator such that the difference is minimized.

That is, processing circuitry of the one or more servers may determine an initial linear operator and update the initial linear operator based on the first training set (e.g., the feature data that form as inputs and the ground truth) and the second training set (e.g., predicted feature data) to minimize a loss function. The linear operator may be the linear operator where the loss function is minimized.

The one or more servers may transmit the linear operator (e.g., “g”) to the processing circuitry of the system (e.g., ADAS) that is configured to predict motion of the objects. Because “g” is a linear operator, the processing circuitry may require fewer computations to predict future feature data as compared to examples where operations are performed based on states with values that change non-linearly over time. For instance, the processing circuitry of the system may be configured to predict future feature data based on the current feature data and the linear operator (e.g., matrix multiplication). In this way, the processing circuitry of the system may predict movement of one or more objects in the image content using scene flow estimation that tends to be more accurate than object-level detection or tracking algorithms, but with reduced complexity due to operations occurring in a linear dynamic system.

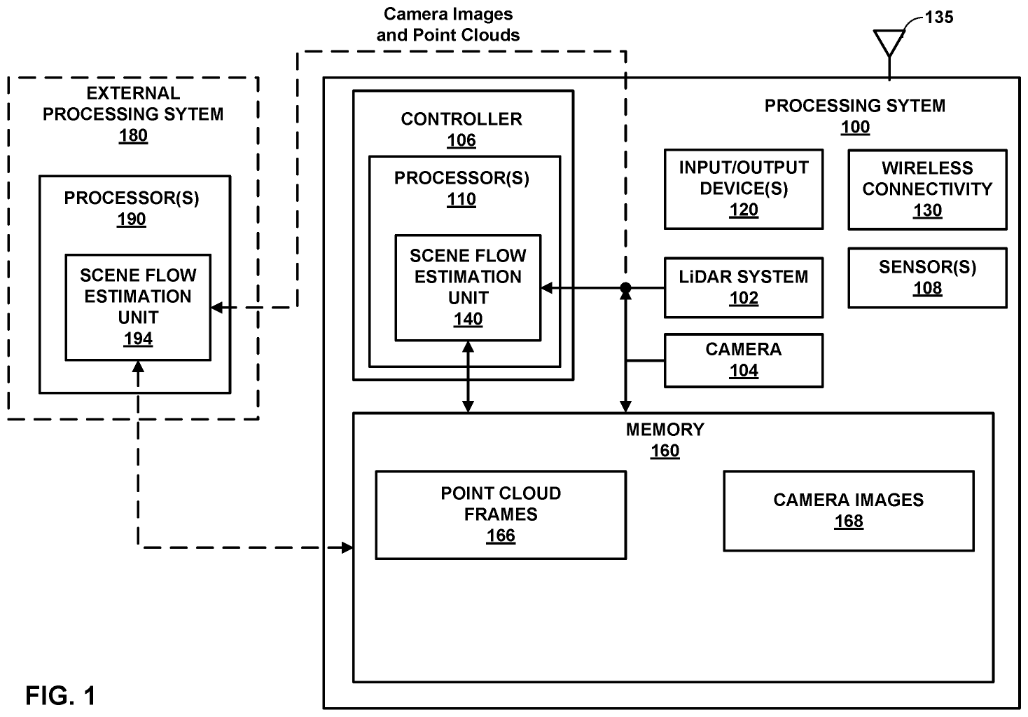

FIG. 1 is a block diagram illustrating an example processing system according to one to more aspects of this disclosure. Processing system 100 may be part of a robotics system, drone system, or other systems that use image content for predicting motion. For case of description, the examples are described with processing system 100 being used in a vehicle, such as an autonomous driving vehicle or an assisted driving vehicle (e.g., a vehicle having an ADAS or an “ego vehicle”). In such an example, processing system 100 may represent an ADAS. As mentioned, in other examples, processing system 100 may be used in other robotic applications that may include one or more sensors. Although described with respect to ADAS, the example techniques may be applicable for other systems as well.

In the example of FIG. 1, the one or more sensors of processing system 100 include LiDAR system 102, camera 104, and sensors 108. For case of illustration and description, the example techniques are described with respect to LiDAR system 102 and camera 104. However, the example techniques may be applicable to examples where there is one sensor. The example techniques may also be applicable to examples where different sensors are used in addition to or instead of LiDAR system 102 and camera 104.

Processing system 100 may also include controller 106, input/output device(s) 120, wireless connectivity component 130, and memory 160. LiDAR system 102 may include one or more light emitters (e.g., lasers) and one or more light sensors. LiDAR system 102 may be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 may emit such pulses in a 360 degree field around so as to detect objects within the 360 degree field, such as objects in front of, behind, or beside a vehicle. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the obj'ct's surface, distance from the sensor, and the angle of incidence. Intensity values can be used for several purposes, including distinguishing different materials, and enhancing visualization. Intensity values can be used to generate a grayscale image of the point cloud, helping to highlight the structure and features in the image content of a scene.

Color information in a point cloud is usually obtained from other sources, such as digital cameras (e.g., camera 104) mounted on the same platform as the LiDAR sensor, and then combined with the LiDAR data, as described in more detail. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 104 may be any type of camera configured to capture video or image data in the scene (e.g., environment) around processing system 100 (e.g., around a vehicle). For example, camera 104 may include a front facing camera (e.g., a front bumper camera, a front windshield camera, and/or a dashcam), a back facing camera (e.g., a backup camera), side facing cameras (e.g., cameras mounted in sideview mirrors). Camera 104 may be a color camera or a grayscale camera. In some examples, camera 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including examples of the one or more sensors 108, such as a sonar sensor, a radar sensor, an infrared camera, and/or a time-of-flight (ToF) camera.

Wireless connectivity component 130 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of the vehicle through the scene (e.g., environment surrounding the vehicle). Controller 106 may include one or more processors, e.g., processor(s) 110. Processor(s) 110 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) 110 in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may also include one or more sensor processing units associated with LiDAR system 102, camera 104, and/or sensor(s) 108. For example, processor(s) 110 may include one or more image signal processors associated with camera 104 and/or sensor(s) 108, and/or a navigation processor associated with sensor(s) 108, which may include satellite-based positioning system components (e.g., GPS or GLONASS) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of processing system 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

As illustrated, processor(s) 110 may include scene flow estimation unit 140. Scene flow estimation unit 140 may be fixed-function circuitry, may be programmable circuitry on which software can execute to perform the functions of scene flow estimation unit 140, or a combination thereof. Scene flow estimation unit 140 may be configured to perform example techniques described in this disclosure of predicting movement of one or more objects in the image content (e.g., of a scene).

In the example of FIG. 1, memory 160 stores point cloud frames 166 and camera images 168. Point cloud frames 166 refer to the raw sensor data from LiDAR system 102, and camera images 168 refer to the raw sensor data from camera 104. Again, it may be possible to use one, both, other, or additional raw sensor data than point cloud frames 166 and camera images 168.

One or more processors 110 may access point cloud frame 166 and camera images 168 from memory 160 and process point cloud frame 166 and camera images 168 to generate point cloud feature data and camera image feature data. In examples where both point cloud frames 166 and camera images 168 are used, scene flow estimation unit 140 may fuse the point cloud feature data and camera image feature data to generate fused feature data. However, where both point cloud frames 166 and camera images 168 are not used, the fusing operation may be bypassed. Scene flow estimation unit 140 may receive the point cloud feature data, the camera image feature data, and/or the fused feature data to predict motion of one or more object in the image content captured from LiDAR system 102 and/or camera 104 over time.

In some examples, one or more processors 110 may partition point cloud frames 166 and camera images 168 include a plurality of grids (e.g., each grid includes 100×100 samples). Scene flow estimation unit 140 may perform the example operations on each grid. For example, scene flow estimation unit 140 may predict movement of one or more objects in the image content on a per-grid basis. For ease of description, the example techniques are described with respect the point cloud feature data or the camera image feature data which may be for an entire frame of the point cloud frame or entire camera image, or may be for a grid of the frame of the point cloud frame or grid of the camera image.

The point cloud feature data or the camera image feature data may be referred to as first feature data. In one or more examples, the first feature data may have a first set of states. The first feature data may be a matrix in an N-dimensional space. Each dimension of the N-dimensions may refer to one of the states in the first set of states. In general, a state refers to characteristic that can be used to describe a scene, such as where there is a value associated with the state. Examples of the states include velocity (e.g., rate of change of sample location in x-direction and y-direction), information of what is inside a grid (e.g., the classification, as described above), direction of samples, etc. In this example, the state may be velocity, grid information, direction, etc., and the first feature data may include values for each of the state.

The direction of samples may be surface normals (e.g., vectors perpendicular to the surfaces within a small region), color (e.g., RGB values from cameras), occupancy (e.g., if a grid is being occupied or not). There are various example techniques to determine surface normals, and the techniques described in this disclosure are not limited to any technique for determining surface normals. For instance, Open3D™ is an open-source library that supports 3D data, and provides for ways of estimating surface normals.

The first set of states may change non-linearly over time (e.g., the values of the first set of states may change non-linearly over time). As explained above, changing non-linearly over time means that a change in values of the first set of states from a first instance to a second instance cannot be represented by a linear operator. Accordingly, the first feature data having the first set of states may be considered as representing a non-linear dynamic system.

In accordance with one or more examples described in this disclosure, scene flow estimation unit 140 may generate second feature data based at least in part on the first feature data. The second feature data may have a second state of states, where the second set of states is greater than the first set of states. In one or more examples, one of the properties of the second feature data may be that the values of second set of states change approximately linearly over time relative to a linear operator.

The second set of states changing approximately linearly over time may mean that by performing a linear operation with the values of second set of states using the linear operator (e.g., matrix multiplication of the linear operator and the values of the second set of states), the result may be a relatively good prediction of the future values of the second set of states. Hence, the values of second set of states change linearly relative of the linear operator. In contrast, for the first set of states, there may be no linear operations with the values of the first set of states that provides a prediction of future values of the first set of states. Instead, complicated, non-linear operations may be needed to predict the future values of the first set of states. Hence, the values of the first set of states do not change linearly.

The amount of linearity may be a function of the number of states in the second set of states. The more states there are, the more linear the second feature data can be. In some examples, the number of states in the second set of states may be twenty or more states, but the techniques are not limited.

In some examples, linearity may be quantified by how long the linear model with the second set of states predicts the future. For instance, how much the predicted states (given the model and states at time 0) deviate from the actual states (at time T). The common time horizons may be between 5 to 30 seconds.

One example way of generating the second set of states is referred to as “lifting.” That is, scene flow estimation unit 140 may convert a non-linear dynamic system to a linear dynamic system by lifting the states (e.g., the first set of states) to a higher dimensional space (e.g., the second set of states). Lifting refers to examples of applying transforms to the first feature data, including the values of the first set of states to generate the second feature data, including the values of the second set of states. As one example, the transform may be mathematical operations such as trigonometric operations (e.g., sine, cosine, tangent, etc.), logarithmic operations (e.g., log, natural log (In), etc.), exponential operations (e.g., squaring, cubing, etc.) that are applied to the first feature data having the first set of states to generate the second feature data having the second set of states. The first feature data may be the point cloud feature data, the camera image feature data, and/or the fused feature data.

In this way, with the example mathematical operations, scene flow estimation unit 140 may lift the first feature data having a first set of states with values that change non-linearly into the second of feature data having a second set of states with values that change linearly, as described. The second feature data may be referred to as xₖ. For instance, xₖ may be one state tensor.

As described above, the first feature data may be the point cloud feature data or the camera image feature data. In examples where both the point cloud feature data and the camera image feature data is used, the other of the point cloud feature data or the camera image feature data may be referred to as third feature data. For instance, scene flow estimation unit 140 may receive first feature data from image content captured with a first sensor (e.g., one of LiDAR system 102 or camera 104) and receive third feature data from image content captured with a second sensor (e.g., other one of LiDAR system 102 or camera 104). The third feature data may also have a first set of states with values that change non-linearly over time.

Scene flow estimation unit 140 may fuse the first feature data and the third feature data to generate fused feature data. For instance, to fuse, scene flow estimation unit 140 may assign color values from camera images 168 to points in point cloud frames 166. In such examples, with the example mathematical operations, scene flow estimation unit 140 may lift the fused feature data having a first set of states with values that change non-linearly into the second feature data having a second set of states. In examples where there is only the first feature data or examples where there is the fused feature data, the second feature data may be referred to as xₖ.

One of the properties of the second set of states may be that the values of the second set of states can be approximated as changing linearly over time relative to a linear operator. For instance, the dynamics of the xₖ may be approximated as a linear system, where x′ₖ₊₁=g∘xₖ. The “∘” symbol refers to the composition operator. The variable “g” is a linear operator that one or more servers (e.g., external processing system 180 that includes processor(s) 190) may determine, as explained in more detail. In the equation, “x” refers to the second feature data having the second set of states, k refers to a timestamp, and x′ₖ₊₁ refers to the predicted future feature data having the second set of states at timestamp k+1.

In one or more examples, based on x′ₖ₊₁, scene flow estimation unit 140 may predict movement of one or more objects in the image content. That is, scene flow estimation unit 140 may predict movement of one or more objects in the image content based at least in part on the second feature data. To predict movement of the one or more object in the image content based at least in part on the second feature data (e.g., xₖ), scene flow estimation unit 140 may determine (e.g., predict) future feature data (e.g., x′ₖ₊₁) based on the linear operator (e.g., “g”) and the second feature data (e.g., xₖ). Based on the future feature data (x′ₖ₊₁), scene flow estimation unit 140 may predict movement of one or more objects in the image content. The future feature data may include values for the second set of states. However, the second set of states may include one or more of the first set of states. That is, the second set of states may include information about the velocity and direction of samples in point cloud frames 166 or camera images 168, from which scene flow estimation unit 140 may predict movement of one or more objects in the image content.

Stated another way, future values of the feature data in subsequent frames or images captured by LiDAR system 102 or camera 104 may be predictable based on the operation of g∘xₖ, where g is a linear operator. For instance, as described above, scene flow estimation unit 140 may be configured to predict movement of one or more objects in the image content. One example way in which to predict the movement (e.g., predict x′ₖ₊₁) is based on g∘xₖ, where g is the linear operator and xₖ is second feature data. For instance, xₖ may be considered as encapsulating hidden states. The states for xₖ may be hidden in the sense that the values of the states are not automatically extracted from the image content, but derived from the image content.

In the above example, scene flow estimation unit 140 may utilize xₖ (e.g., second feature data) and x′ₖ₊₁ (e.g., future feature data) to predict movement of objects at time k+1. However, the example techniques are not so limited. In some examples, scene flow estimation unit 140 may predict a plurality of future feature data (e.g., x′ₖ₊₁, x′ₖ₊₂, x′ₖ₊₃, and so forth based on xₖ and the linear operator “g”). Scene flow estimation unit 140 may predict the movement of objects at time k+1, k+2, k+3, and so forth. That is, scene flow estimation unit 140 may predict the movement of objects for a period of time (e.g., 5 to 30 seconds).

The linear operator “g” describes how the values of the second set of states change over time (e.g., how the state evolves). One or more servers (e.g., external processing system 180) may be configured to determine the linear operator “g”. For instance, the linear operator, an example of which is the Koopman operator, may be learnable based on a loss function. The inputs to the loss function may be training data that includes a first training set of feature data having the second set of states and a second training set of predicted feature data having the second set of states.

To avoid confusion, second feature data having the second set of states is referred to as xₖ. The first training set of feature data is referred to tₙ, the second training set of predicted feature data is referred to as t′n. In one or more examples, one or more servers (e.g., external processing system 180) may be configured to generate the predicted feature data (e.g., t′n) based on tₙ₋₁. That is, t′n is a prediction of the feature data having the second set of states, and tₙ is the actual feature data having the second set of states. Accordingly, the first training set of feature data may include tₙ, with n=0 to N. The second training set of predicted feature data may include t′ₙ, with n=1 to N, where t′ₙ is predicted from tₙ₋₁ and the linear operator.

In one or more examples, to determine the linear operator (e.g., “g”), external processing system 180 (e.g., one or more servers) may determine an initial value for the linear operator. External processing system 180 (e.g., via processor(s) 190) may update a current value of the linear operator, starting from the initial value, to determine a new current value based on the first training set and the second training set to minimize a loss function. The value of the linear operator may be the current value of the linear operator where the loss function is minimized.

For instance, the first training set may initially be tₙ. In one example, the second training set may be predicted feature data. Using the initial value of the linear operator and tₙ₋₁, external processing system 180 may determine t′ₙ. External processing system 180 may determine a plurality of t′ₙ based on the linear operator. External processing system 180 may determine the loss value based on a difference between respective pairs of tₙ and t′ₙ (e.g., calculating the difference being an example of the loss function). Then, external processing system 180 may update the current value of the linear operator to a new current value of the linear operator. External processing system 180 may repeat the above steps using the new current value of the linear operator until difference between respective pairs of tₙ and t′ₙ is minimized. The value of the linear operator may be the current value of the linear operator where the loss function is minimized.

In some examples, external processing system 180 may utilize an iterative process to iteratively update the value of the linear operator. For instance, external processing system 180 may start with an initial value for the linear operator, and predict values for t′ₙ₋₁ based on tₙ₋₂ and the initial value of the linear operator. External processing system 180 may determine a difference between t′ₙ₋₁ and tₙ₋₁, and update the value of the linear operator based on the difference. External processing system 180 may then predict values for t′ₙ based on tₙ₋₁ and the updated current value of the linear operator, and repeat such operations until the difference is minimized to determine the value of the linear operator (e.g., “g”).

Although the example techniques are described with respect to processor(s) 110, such as scene flow estimation unit 140, the example techniques are not so limited. For instance, the techniques of this disclosure may also be performed by external processing system 180. External processing system 180 may include processor(s) 190, which may be any of the types of processors described above for processor(s) 110. Processor(s) 190 may include scene flow estimation unit 194 and may acquire point cloud frames 166 and camera images 168 directly from LiDAR system 102 and camera 104, respectively, or from memory 160. Though not shown, external processing system 180 may also include a memory that may be configured to store point cloud frames.

In some examples, scene flow estimation unit 140 may perform the example techniques described in this disclosure without assistance from scene flow estimation unit 194, such as in examples where external processing system 180 is not available or utilized. In some examples, scene flow estimation unit 194 may perform the example techniques described in this disclosure without assistance from scene flow estimation unit 140. In such examples, processor(s) 190 may output information indicative of a prediction of movement of one or more objects in the image content to processor(s) 110, and processor(s) 110 may then utilize the information for vehicle control.

In some examples, scene flow estimation unit 140 and scene flow estimation unit 194 may together perform the example techniques described in this disclosure. As an example, scene flow estimation unit 194 may determine the linear operator (e.g., “g”), and scene flow estimation unit 140 may use the linear operator to predict movement of one or more objects in the image content and control the vehicle based on the predicted movement. For ease of illustration, the examples are described with respect to scene flow estimation unit 194 determining the linear operator, external processing system 180 (e.g., one or more servers) outputting the determined linear operator to processor 110, and scene flow estimation unit 140 performing the scene flow estimation (e.g., prediction of movement of objects).

In one or more examples, to determine the linear operator, external processing system 180 may receive image content captured from various vehicles, drones, robots, etc. during operations of those devices. External processing system 180 may utilize such image content as training data for determining the linear operator. That is, the training data may be tₙ, where tₙ₋₁ is used to predict values (e.g., t′ₙ), and the difference between tₙ and t′ₙ is used to determine the linear operator. For instance, tₙ is the ground truth and t′ₙ is a prediction (e.g., inference of the learning), and external processing system 180 determines the linear operator based on minimizing the difference between tₙ and t′ₙ.

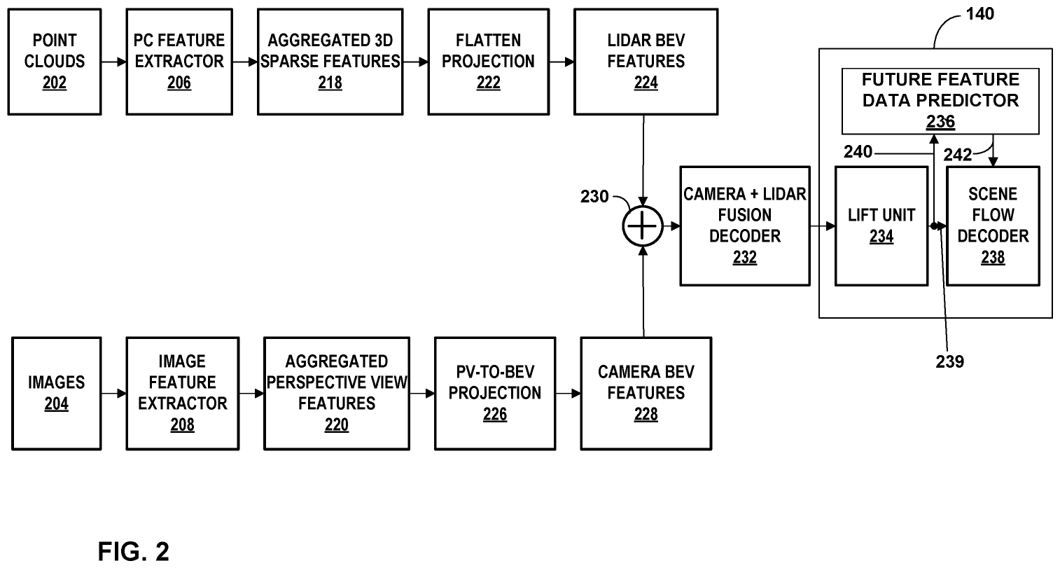

FIG. 2 is a flowchart illustrating an example process predicting movement of objects. In the example of FIG. 2, one or more processors 110 acquire point clouds (202) and acquires images (204). The point clouds and images may constitute raw data acquired by sensors, such as LiDAR system 102 and camera 104, respectively.

One or more processors 110 perform point-cloud feature extraction (206) on the acquired point clouds and perform image features extraction (208) on the acquired images. One or more processors 110 may, for example, identify shapes, lines, or other features in the point clouds and images that may correspond to real-world objects of interest. Performing feature extraction on the raw data may reduce the amount of data in the frames as some information in the point clouds and images may be removed. For example, data corresponding to unoccupied voxels of a point cloud may be removed.

One or more processors 110 may store a set of aggregated 3D sparse features (218). That is, one or more processors 110 may maintain a buffer with point cloud frames. The point clouds in the buffer, due to feature extraction and/or down sampling, may have reduced data relative to the raw data acquired by LiDAR system 102. One or more processors 110 may add new point clouds to the buffer at a fixed frequency and/or in response to processing system 100 having moved a threshold unit of distance.

One or more processors may store a set of aggregated perspective view features (220). That is, one or more processors 110 may maintain a buffer with sets of images. The images in the buffer, due to feature extraction and/or down sampling, may have reduced data relative to the raw data acquired by camera 104. One or more processors 110 may add new images to the buffer at a fixed frequency and/or in response to processing system 100 having moved a threshold unit of distance.

One or more processors 110 may flatten projection (222) on the point cloud frames, e.g., on the aggregated 3D sparse features. Flatten projection converts the 3D point cloud data into 2D data, which creates a birds-eye-view (BEV) perspective of the point cloud (224), e.g., data indicative of LiDAR BEV features in the point clouds. One or more processors 110 may perform perspective view (PV)-to-BEV projection (226) on the images, e.g., the aggregated perspective view features. PV-to-BEV projection converts the image data into 2D BEV data, using for example matrix multiplication, which creates data indicative of camera BEV features (228).

The LiDAR BEV features in the point cloud, also called point cloud feature data, is one example of first feature data having a first set of states with values that change non-linearly over time. Camera BEV features, also called camera image feature data, is another example of first feature data having a first set of states with values that change non-linearly over time. As noted above, the first feature data having the first set of states with values that change non-linearly over time (e.g., point cloud feature data or camera image feature data) include examples where the first set of states are such that the values of the first set of states tend to have the characteristic of changing non-linearly. It may be possible that the first feature data having the first set of states with values that change non-linearly over time include examples where the values of the first set of states are required to change non-linearly over time. However, the example techniques are not so limited. The examples of the first feature data having the first set of states with values that change non-linearly should not be limited to examples where there is a requirement that the values change non-linearly, and include examples where values are for states that tend to exhibit non-linear behavior. It may be possible that some of the values for the first set of states in the first feature data exhibit linear behavior at times.

Each point cloud frame, e.g., each aggregated 3D sparse feature (218), and each image, e.g., each aggregated perspective view features (220) may have associated timestamp, location, and pose information. Based on the timestamp, location (e.g., GPS location), and pose information for the point cloud frames and the images, one or more processors 110 may transform the images to be in the same coordinate domain as the point cloud frames or may shift the point clouds to be in the same coordinate domain as the images.

The LiDAR BEV features and the camera BEV features are combined (230) and input into a camera/LiDAR fusion decoder 232. Camera/LiDAR fusion decoder 232 may also be referred to as a cross-modal attention network. The fusion decoder extracts features from a feature space and decodes those features into a scene space corresponding to the originally-acquired point clouds and images.

As illustrated in FIG. 2, the output of camera/LiDAR fusion decoder 232 (e.g., cross-modal attention network) is fed to scene flow estimation unit 140. Although FIG. 2 illustrates LiDAR BEV features (e.g., point cloud feature data) and camera BEV features (e.g., camera image feature data), in some examples, one of, but not necessarily both of, point cloud feature data and camera image feature data may be utilized. In such examples, camera/LiDAR fusion decoder 232 may not be needed.

Accordingly, in some examples, the input to scene flow estimation unit 140 may be first feature data (e.g., one of but not necessarily both of point cloud feature data or camera image feature data). However, in some examples where camera/LiDAR fusion decoder 232 is utilized, the first feature data may be one of the point cloud feature data or the camera image feature data, and third feature data having the first set of states may be the other of point cloud feature data or the camera image feature data. The camera/LiDAR fusion decoder 232 may fuse the first feature data and the third feature data to generate fused feature data, and the fused feature data may be the input to scene flow estimation unit 140.

In the example illustrated in FIG. 2, scene flow estimation unit 140 includes lift unit 234, future feature data predictor 236, and scene flow decoder 238. As described in more detail, lift unit 234 may generate second feature data 239 based at least in part on the first feature data, where the second feature data has a second set of states with values that change approximately linearly over time relative to a linear operator. In one or more examples, second set of states with values that change approximately linearly over time relative to the linear operator may mean that a linear operation (e.g., multiplication, division, addition, subtraction) on the values of second set of states using the linear operator may be indicative of future values of the second set of states. In some examples, the equation to predict future values of the second set of states using the linear operator may have a maximum of one degree (e.g., in the equation, any variable is raised to a maximum of power of one). For non-linear systems (e.g., the first set of states), the maximum degree may be greater than one for a variable to predict a future value of the first set of states.

In examples where camera/LiDAR fusion decoder 232 is not needed, lift unit 234 may generate the second feature data 239 based on the first feature data (e.g., one of point cloud feature data or camera image feature data). In examples where camera/LiDAR fusion decoder 232 is used, lift unit 234 may generate the second feature data 239 based on the fused feature data, where the fused feature data is generated based on the first feature data and the third feature data. Therefore, even in examples where camera/LiDAR fusion decoder 232 is used, lift unit 234 may still be considered as generating second feature data 239 based at least in part on the first feature data.

Also, the camera/LiDAR fusion decoder 232 is illustrated as external to scene flow estimation unit 140. However, the example techniques are so limited. In some examples, the operation of camera/LiDAR fusion decoder 232 may be combined with the operations of lift unit 234. Accordingly, in the example illustrated in FIG. 2, lift unit 234 may generate the second feature data 239 based on the fused feature data. However, in examples in which camera/LiDAR fusion decoder 232 and lift unit 234 are combined, the combined camera/LiDAR fusion decoder 232 and lift unit 234 may be configured to generate the second feature data 239 during the fusing of the first feature data and the third feature data. Stated another way, generating second feature data 239 includes generating second feature data 239 based on the fused feature data or during the fusing of the first feature data and the third feature data.

As described, lift unit 234 may generate the second feature data 239 based at least in part on the first feature data (e.g., first feature data and/or fused feature data). The second feature data 239 has a second set of states with values that change approximately linearly over time relative to a linear operator, and the second set of states is greater than the first set of states. For instance, the second feature data 239 may be represented as xₖ, where the dimensional space (e.g., number of states) is greater than the dimensional space of the first feature data or the fused feature data.

To generate the second feature data 239, lift unit 234 may be configured to perform mathematical operations on the first feature data. For instance, lift unit 234 may determine a x\hat{ }2, x\hat{ }3, cosine, sine, etc. of the values of first feature data to lift the first feature data having the first set of states to second feature data 239 having the second set of states. The particular equations used by lift unit 234 to lift the states may be different for different systems, and determined based on evaluation of which equations provide accurate results.

Scene flow estimation unit 140 may also include future feature data predictor 236. In one or more examples, future feature data predictor 236 may be configured to determine the linear operator relative to which the second feature data 239 is linear. That is, future feature data may be predictable based on the linear operator and the second feature data 239. Future feature data predictor 236 may be configured to generate a prediction of future feature data represented as x′ₖ₊₁.

In one or more examples, future feature data predictor 236 may be configured to receive the linear operator. For instance, future feature data predictor 236 may receive the linear operator from one or more servers (e.g., external processing system 180) that are configured to determine the linear operator based on training data.

The training data includes a first training set of feature data. For instance, external processing system 180 may receive the first training set of feature data from image content captured from other vehicles, drones, robots, etc. The first training set of feature data may have the second set of states. External processing system 180 may determine the second training set as predicted feature data (e.g., feature data that is predicted from the first training set of feature data). External processing system 180 may determine a linear operator that minimizes the difference between the second training set and the first training set.

External processing system 180 (e.g., via scene flow estimation unit 194) may determine an initial value for the linear operator, and update a current value of the linear operator, starting from the initial value, to determine a new current value based on the first training set and the second training set to minimize a loss function. As one example, external processing system 180 may determine an initial value for the linear operator, and iteratively update a current value of the linear operator, starting from the initial value, to determine a new current value based on iterations of the first training set and the second training set to minimize a loss function. For instance, external processing system 180 may use the value of tₙ and t′ₙ, where t′ₙ is predicted feature data predicted from tₙ₋₁. For example, external processing system 180 may determine g (tₙ₋₁) to determine t′ₙ (e.g., a prediction of tₙ), where “g” is the current value for the linear operator and g (tₙ₋₁) includes linear operations (e.g., only linear operations). The value of tₙ may be the actual value.

One example of the loss function may be:

$$Loss = ( 1 / a ) * ( summation from n to a of ( {‖ {t}_{n} - {t}_{n}^{′} ‖}^{2} ) )$$

For example, external processing system 180 may have used tₙ₋₂ and an initial value of “g” (e.g., linear operator) to determine t′ₙ₋₁ (e.g., g (tₙ₋₂)=t′ₙ₋₁). In this example, external processing system 180 may update the value of the linear operator based on the loss calculation of (tₙ₋₁−t′ₙ₋₁). Then, for the next image frame, external processing system 180 may receive the value of tₙ₋₁, and determine t′ₙ based on the current (e.g., now updated) value of the linear operator (e.g., g (tₙ₋₁)=t′ₙ). External processing system 180 may determine a loss value based on difference between (tₙ−t′ₙ). External processing system 180 may update the value of the linear operator, and keep repeating these example operations to minimize the loss function.

As another example, instead of performing iterative operations, external processing system 180 may determine the value of the linear operator based on receiving batches of feature data. For instance, external processing system 180 may receive tₙ, tₙ₊₁, tₙ₊₂, and tₙ₊₃. In this example, external processing system 180 may predict t′ₙ₊₁ and t′ₙ₊₃ based on an initial value of the linear operator and tₙ and tₙ₊₂, respectively (e.g., g (tₙ)=t′ₙ₊₁ and g (tₙ₊₂)=t′ₙ₊₃)). External processing system 180 may determine a difference between t′ₙ₊₃ and tₙ₊₃ and t′ₙ₊₁ and tₙ₊₁, update the value of the linear operator, and repeat to determine a linear operator that minimizes the difference. Although two pairs of feature data (e.g., tₙ₊₁ and t′ₙ₊₁ and tₙ₊₃ and t′ₙ₊₃) are described, there may be a plurality of pairs of feature data that are used to determine the value of the linear operator.

Future feature data predictor 236 may receive the determine linear operator. With the value of the linear operator, future feature data predictor 236 may predict future feature data 242 (e.g., x′ₖ₊₁), which may be a prediction of the future state values of the values of the second set of states of xₖ. Scene flow decoder 238 may receive the second feature data 239 (e.g., xₖ) and the future feature data 242 (e.g., x′ₖ₊₁), and predict the movement of one or more objects based at least in part on the second feature data 239 and the future feature data 242. As one example, future feature data predictor 236 may generate future feature data 242 (e.g., x′ₖ₊₁) based on performing at least one of matrix multiplication or convolution between linear operator (e.g., g) and the second feature data 242 (e.g., xₖ).

In the above example, scene flow decoder 238 is described as receiving xₖ and x′ₖ₊₁. In some examples, it may be possible for scene flow decoder 238 to receive xₖ and x′ₖ₊₂ or any other x′_{k+N}. It may be possible for scene flow decoder 238 to receive x′_{k+N-1} and x′_{k+N}. In these examples, future feature data predictor 236 may use the linear operator received from the one or more servers (e.g., external processing system 180) to generate x′_{k+N} or x′_{k+N-1}. This way, scene flow decoder 238 may determine a prediction of movement of objects over a period of time (e.g., over 5 to 30 seconds).

In some examples, the output of scene flow decoder 238 may be a color map where different colors represent a prediction of movement (e.g., direction, velocity, etc.) of objects in the image content. That is, one color may represent that an object is moving at the same speed as the vehicle that includes processing system 100, another color may represent an object is moving faster than the vehicle that includes processing system 100, and another color may represent an object is moving in a different direction than the vehicle that includes processing system 100. The output of scene flow decoder 238 being a color map is provided as merely one example, and the techniques should not be considered limited.

For instance, the output of scene flow decoder 238 may be a set of points, and each point on the image is associated with a flow vector. That is, the output of scene flow decoder 238 may be a flow vector map. Empty spaces may mean no valid flow.

Scene flow decoder 238 may determine a difference between values of respective states between xₖ and x′ₖ₊₁. The difference may be indicated via the color map or flow vector map, and indicate a prediction of objects in the image content at timestamp k+1. As one example, if the value of the velocity (e.g., one of the states) in xₖ and x′ₖ₊₁, for samples in the image frame that correspond to an object, is the same, then scene flow decoder 238 may indicate through the color map or flow vector map that the object velocity is not changing at timestamp k+1 (e.g., which is in the future).

Processing system 100 may then predict intended movements of moving objects. For example, processing system 100 may predict whether a pedestrian intends to cross a street or turn a corner, or whether a car intends to stop at a stop sign using the output from scene flow decoder 238. Based on the predicted intended movements, processing system 100 may perform a navigation function based on the predicted trajectory. For example, processing system 100 may cause an ego vehicle to accelerate, decelerate, stop, etc. As described above, processing system 100 may also be configured to generate a prediction of movement of objects over a period of time (e.g., 5 to 30 seconds). This may allow processing system 100 with more time to determine which actions to take, resulting in smoother changes rather than sudden stops or changes.

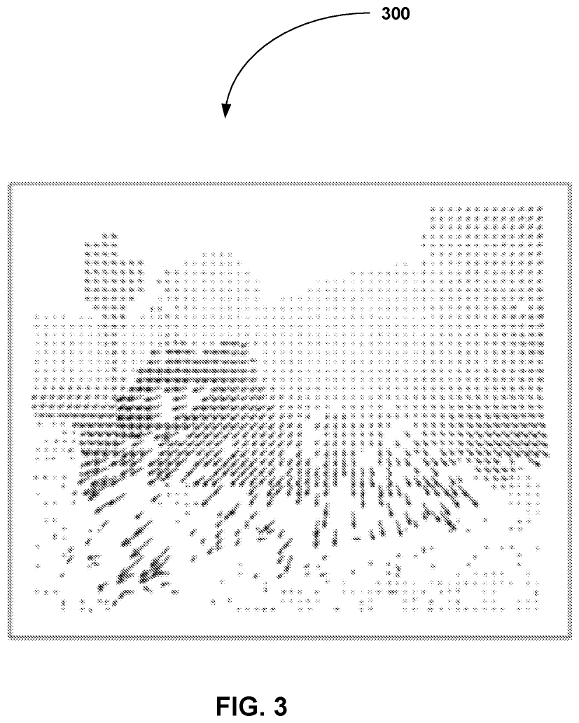

FIG. 3 is a conceptual diagram illustrating information indicative of predicted movement of objects. As described above, the output of scene flow decoder 238 may be a flow vector map or a color map. FIG. 3 illustrates an example of flow vector map 300 in which each point on the image is associated with a flow vector indicative of motion of the point. Empty spaces may mean no valid flow.

In examples where the output of scene flow decoder 238 is a color map, the color of a first object may be one color because the movement of the first object may indicate that the first object is going straight and at same rate as the vehicle that includes processing system 100. The color of a second object may be another color because the movement of the second object may indicate that the second object is turning and/or has a different rate than the vehicle that includes processing system 100. The color of a third object may be yet another color because the movement of the third object may indicate that the third object is accelerating relative to the vehicle that includes processing system 100.

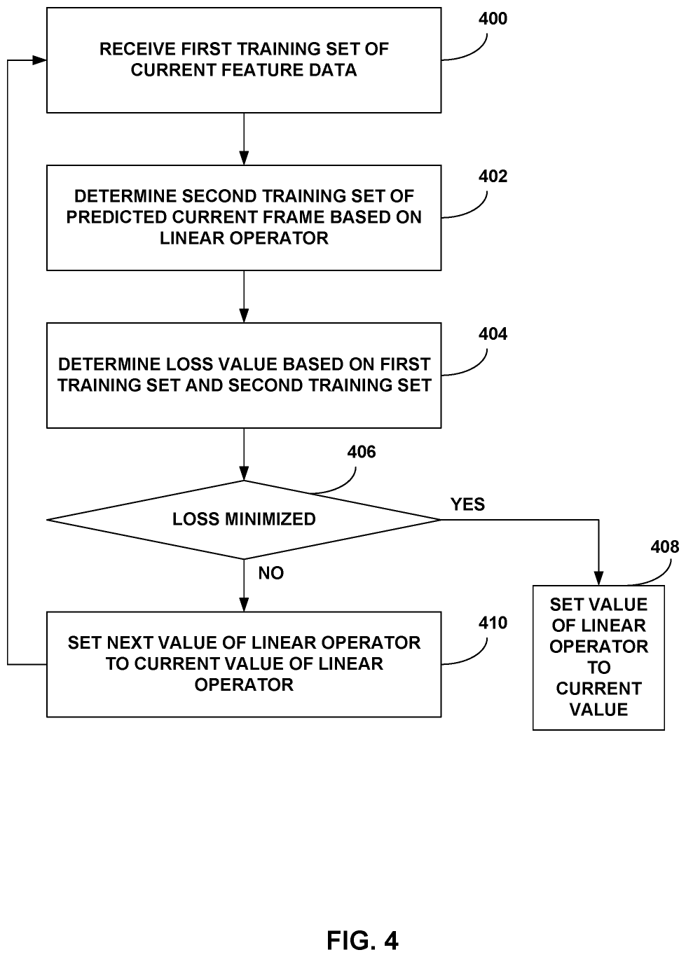

FIG. 4 is a flowchart illustrating an example process for determining a linear operator for predicting movement of objects. For instance, FIG. 4 illustrates an example in which external processing system 180 (e.g., via processors 190) may determine the linear operator based on training data. The training data may include a first training set of feature data having the second set of states and a second training set of predicted feature data having the second set of states.

For instance, external processing system 180 may determine an initial value for the linear operator, and update a current value of the linear operator, starting from the initial value, to determine a new current value based on the first training set and the second training set to minimize a loss function. A value of the linear operator may be the current value of the linear operator where the loss function is minimized.

In the example of FIG. 4, external processing system 180 may receive first training set of feature data (e.g., tₙ₋₁ and tₙ) (400). For instance, external processing system 180 may receive feature data stored in memory of external processing system 180 that is from other vehicles, drones, robots, etc. in variety of different environments. External processing system 180 may determine second training set of predicted feature data (e.g., t′ₙ) based on current value of linear operator (402). As one example, external processing system 180 may perform at least one of matrix multiplication or convolution between the linear operator and tₙ₋₁ to generate predicted feature data (e.g., t′ₙ).

External processing system 180 may determine a loss value based on the first training set and the second training set (404). For instance, external processing system 180 may determine a loss value based on difference between tₙ and t′ₙ. In examples where the loss value is not necessarily computed iteratively, there may be a plurality of values of tₙ and t′ₙ that are used (e.g., tₙ, tₙ₊₁, tₙ₊₂, tₙ₊₃, t′ₙ₊₁, and t′ₙ₊₃, as described above). External processing system 180 may determine whether the loss value is minimized (406). If the loss value is minimized (YES of 406), the current value of the linear operator may be set as the value of the linear operator that is used to generate future feature data (e.g., x′ₖ₊₁).

If the loss value is not minimized (NO of 406), external processing system 180 may set the next value of the linear operator to current value of the linear operator (e.g., update the value of “g”) (410). There may be various ways to update the value of “g”. For example, g is a function with tunable coefficients (e.g., a deep neural network in this case). External processing system 180 may use gradient descent to optimize the coefficients (e.g., weights) of the linear operator (“g”). External processing system 180 may then repeat the example operations in FIG. 4 until the loss function is minimized (e.g., until YES of 406).

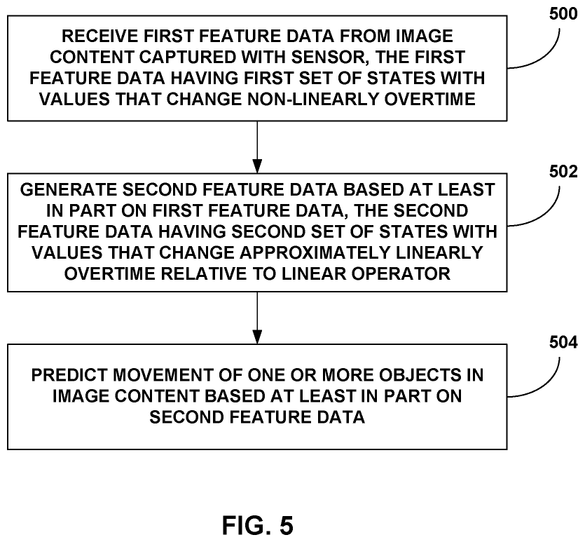

FIG. 5 is a flowchart illustrating an example method in accordance with one or more examples described in this disclosure. The example of FIG. 5 is described with respect to processing circuitry performing the example techniques. Example of the processing circuitry includes one or more processors 110 or 190 that include scene flow estimation unit 140 or 194, respectively.

The processing circuitry may receive first feature data from image content captured with a sensor, the first feature data having a set of states with values that change non-linearly over time (500). Examples of the first feature data include the point cloud feature data (e.g., LiDAR BEV features 224) or camera image feature data (e.g., camera BEV features 228).

In some examples, the sensor may be a first sensor. The processing circuitry may receive a third feature data from image content captured with a second sensor. For instance, if the first feature data is point cloud feature data, then the third feature data may be camera image feature data, or vice-versa. The processing circuitry may fuse the first feature data and the third feature data to generate fused feature data (e.g., via camera/LiDAR fusion decoder 232). As one example, the first sensor may be camera 104, and the second sensor may be LiDAR system 102.

The processing circuitry may generate second feature data based at least in part on the first feature data, the second feature data having a second set of states with values that change approximately linearly over time relative to a linear operator (502). The second set of states may be greater than the first set of states. For instance, the second feature data may be xₖ that lift unit 234 generated by lifting the values of the first set of states of the first feature data or the fused feature data to a higher dimensional space. In some examples, the processing circuitry may generate the second feature data based on the fused feature data or during the fusing of the first feature data and the third feature data.

In one or more examples, the processing circuitry (e.g., of external processing system 180, which is an example of one or more servers) may determine the linear operator (e.g., a Koopman operator) based on training data, where the training data includes a first training set of feature data having the second set of states and a second training set of predicted feature data having the second set of states. For instance, to determine the linear operator, external processing system 180 may be configured to determine an initial value for the linear operator, and update a current value of the linear operator, starting from the initial value, to determine a new current value based on the first training set and the second training set to minimize a loss function. In this example, a value of the linear operator may be the current value of the linear operator where the loss function is minimized.

The processing circuitry (e.g., of processing system 100) may predict movement of one or more objects in the image content based at least in part on the second feature data (504). For example, the processing circuitry may generate future feature data (e.g., x′ₖ₊₁) based on the second feature data (e.g., xₖ) and the linear operator (e.g., “g”). As an example, to generate the future feature data (e.g., x′ₖ₊₁) based on the second feature data (e.g., xₖ) and the linear operator (e.g., g), the processing circuitry may be configured to perform at least one of matrix multiplication or convolution between the linear operator (e.g., g) and the second feature data (e.g., xₖ). The processing circuitry may predict the movement of the one or more objects in the image content based at least in part on the second feature data (e.g., xₖ) and the future feature data (e.g., x′ₖ₊₁). The processing circuitry may control operation of a vehicle based on the prediction of the movement of the one or more objects (e.g., brake, output warning, turn, etc).

The following numbered clauses illustrate one or more aspects of the devices and techniques described in this disclosure.

Clause 1. A method of image processing, the method comprising: receiving first feature data from image content captured with a sensor, the first feature data having a first set of states with values that change non-linearly over time; generating second feature data based at least in part on the first feature data, the second feature data having a second set of states with values that change approximately linearly over time relative to a linear operator, wherein the second set of states is greater than the first set of states; and predicting movement of one or more objects in the image content based at least in part on the second feature data.

Clause 2. The method of clause 1, further comprising receiving the linear operator, wherein predicting the movement of the one or more objects comprises: generating future feature data based on the second feature data and the linear operator; and predicting the movement of the one or more objects in the image content based at least in part on the future feature data.

Clause 3. The method of clause 2, wherein generating the future feature data based on the second feature data and the linear operator comprises: performing at least one of matrix multiplication or convolution between the linear operator and the second feature data.

Clause 4. The method of any of clauses 2 and 3, wherein receiving the linear operator comprises receiving the linear operator from one or more servers that are configured to determine the linear operator based on training data.

Clause 5. The method of any of clauses 1-4, further comprising: determining the linear operator based on training data, the training data comprising a first training set of feature data having the second set of states and a second training set of predicted feature data having the second set of states.

Clause 6. The method of clause 5, wherein determining the linear operator comprises: determining an initial value for the linear operator; and updating a current value of the linear operator, starting from the initial value, to determine a new current value based on the first training set and the second training set to minimize a loss function, wherein a value of the linear operator comprises the current value of the linear operator where the loss function is minimized.

Clause 7. The method of any of clauses 1-6, wherein the linear operator comprises a Koopman operator.

Clause 8. The method of any of clauses 1-7, wherein the sensor comprises a first sensor, the method further comprising: receiving a third feature data from image content captured with a second sensor; fusing the first feature data and the third feature data to generate fused feature data, wherein generating second feature data comprises generating second feature data based on the fused feature data or during the fusing of the first feature data and the third feature data.

Clause 9. The method of clause 8, wherein the first sensor is a camera, and the second sensor is a LiDAR system.

Clause 10. The method of any of clauses 1-9, wherein generating the second feature data comprises: lifting the first feature data having the first set of states to generate the second feature data having the second set of states.

Clause 11. The method of any of clauses 1-10, further comprising: controlling movement of a vehicle based on the movement of the one or more objects.

Clause 12. A system for image processing, the system comprising: one or more memories; and processing circuitry coupled to the one or more memories and configured to: receive first feature data from image content captured with a sensor, the first feature data having a first set of states with values that change non-linearly over time; generate second feature data based at least in part on the first feature data, the second feature data having a second set of states with values that change approximately linearly over time relative to a linear operator, wherein the second set of states is greater than the first set of states; and predict movement of one or more objects in the image content based at least in part on the second feature data.

Clause 13. The system of clause 12, wherein the processing circuitry is configured to receive the linear operator, wherein to predict the movement of the one or more objects, the processing circuitry is configured to: generate future feature data based on the second feature data and the linear operator; and predict the movement of the one or more objects in the image content based at least in part on the future feature data.

Clause 14. The system of clause 13, wherein to generate the future feature data based on the second feature data and the linear operator, the processing circuitry is configured to: perform at least one of matrix multiplication or convolution between the linear operator and the second feature data.

Clause 15. The system of any of clauses 13 and 14, wherein to receive the linear operator, the processing circuitry is configured to receive the linear operator from one or more servers that are configured to determine the linear operator based on training data.

Clause 16. The system of any of clauses 12-15, wherein the linear operator comprises a Koopman operator.

Clause 17. The system of any of clauses 12-16, wherein the sensor comprises a first sensor, and wherein the processing circuitry is configured to: receive a third feature data from image content captured with a second sensor; fuse the first feature data and the third feature data to generate fused feature data, wherein to generate second feature data, the processing circuitry is configured to generate second feature data based on the fused feature data or during the fusing of the first feature data and the third feature data.

Clause 18. The system of clause 17, wherein the first sensor is a camera, and the second sensor is a LiDAR system.

Clause 19. The system of any of clauses 12-18, wherein to generate the second feature data, the processing circuitry is configured to: lift the first feature data having the first set of states to generate the second feature data having the second set of states.

Clause 20. The system of any of clauses 12-19, wherein the processing circuitry is configured to: control movement of a vehicle based on the movement of the one or more objects.

Clause 21. A computer-readable storage medium storing instructions thereon that when executed cause one or more processors to: receive first feature data from image content captured with a sensor, the first feature data having a first set of states with values that change non-linearly over time; generate second feature data based at least in part on the first feature data, the second feature data having a second set of states with values that change approximately linearly over time relative to a linear operator, wherein the second set of states is greater than the first set of states; and predict movement of one or more objects in the image content based at least in part on the second feature data.

Clause 22. The computer-readable storage medium of clause 21, further comprising instructions that cause one or more processors to perform the method of any of clauses 2-11.

Clause 23. A system for image processing, the system comprising means for performing the method of any of clauses 1-11.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of image processing, the method comprising:
receiving first feature data from image content captured with a sensor, the first feature data having a first set of states with values that change non-linearly over time;
generating second feature data based at least in part on the first feature data, the second feature data having a second set of states with values that change approximately linearly over time relative to a linear operator, wherein the second set of states is greater than the first set of states; and
predicting movement of one or more objects in the image content based at least in part on the second feature data.

2. The method of claim 1, further comprising receiving the linear operator,
wherein predicting the movement of the one or more objects comprises:
generating future feature data based on the second feature data and the linear operator; and
predicting the movement of the one or more objects in the image content based at least in part on the future feature data.

3. The method of claim 2, wherein generating the future feature data based on the second feature data and the linear operator comprises:
performing at least one of matrix multiplication or convolution between the linear operator and the second feature data.

4. The method of claim 2, wherein receiving the linear operator comprises receiving the linear operator from one or more servers that are configured to determine the linear operator based on training data.

5. The method of claim 1, further comprising:
determining the linear operator based on training data, the training data comprising a first training set of feature data having the second set of states and a second training set of predicted feature data having the second set of states.

6. The method of claim 5, wherein determining the linear operator comprises:
determining an initial value for the linear operator; and
updating a current value of the linear operator, starting from the initial value, to determine a new current value based on the first training set and the second training set to minimize a loss function,
wherein a value of the linear operator comprises the current value of the linear operator where the loss function is minimized.

7. The method of claim 1, wherein the linear operator comprises a Koopman operator.

8. The method of claim 1, wherein the sensor comprises a first sensor, the method further comprising:
receiving a third feature data from image content captured with a second sensor; and
fusing the first feature data and the third feature data to generate fused feature data,
wherein generating second feature data comprises generating second feature data based on the fused feature data or during the fusing of the first feature data and the third feature data.

9. The method of claim 8, wherein the first sensor is a camera, and the second sensor is a LiDAR system.

10. The method of claim 1, wherein generating the second feature data comprises:
lifting the first feature data having the first set of states to generate the second feature data having the second set of states.

11. The method of claim 1, further comprising:
controlling operation of a vehicle based on the movement of the one or more objects.

12. A system for image processing, the system comprising:
one or more memories; and
processing circuitry coupled to the one or more memories and configured to:
receive first feature data from image content captured with a sensor, the first feature data having a first set of states with values that change non-linearly over time;
generate second feature data based at least in part on the first feature data, the second feature data having a second set of states with values that change approximately linearly over time relative to a linear operator, wherein the second set of states is greater than the first set of states; and
predict movement of one or more objects in the image content based at least in part on the second feature data.

13. The system of claim 12, wherein the processing circuitry is configured to receive the linear operator,
wherein to predict movement of the one or more objects, the processing circuitry is configured to:
generate future feature data based on the second feature data and the linear operator; and
predict the movement of the one or more objects in the image content based at least in part on the future feature data.

14. The system of claim 13, wherein to generate the future feature data based on the second feature data and the linear operator, the processing circuitry is configured to:
perform at least one of matrix multiplication or convolution between the linear operator and the second feature data.

15. The system of claim 13, wherein to receive the linear operator, the processing circuitry is configured to receive the linear operator from one or more servers that are configured to determine the linear operator based on training data.

16. The system of claim 12, wherein the linear operator comprises a Koopman operator.

17. The system of claim 12, wherein the sensor comprises a first sensor, and wherein the processing circuitry is configured to:
receive a third feature data from image content captured with a second sensor; and
fuse the first feature data and the third feature data to generate fused feature data,
wherein to generate second feature data, the processing circuitry is configured to generate second feature data based on the fused feature data or during the fusing of the first feature data and the third feature data.

18. The system of claim 17, wherein the first sensor is a camera, and the second sensor is a LiDAR system.

19. The system of claim 12, wherein to generate the second feature data, the processing circuitry is configured to:
lift the first feature data having the first set of states to generate the second feature data having the second set of states.

20. The system of claim 12, wherein the processing circuitry is configured to:
control operation of a vehicle based on the movement of the one or more objects.

21. A computer-readable storage medium storing instructions thereon that when executed cause one or more processors to:
receive first feature data from image content captured with a sensor, the first feature data having a first set of states with values that change non-linearly over time;
generate second feature data based at least in part on the first feature data, the second feature data having a second set of states with values that change approximately linearly over time relative to a linear operator, wherein the second set of states is greater than the first set of states; and
predict movement of one or more objects in the image content based at least in part on the second feature data.
